(19) United States
(12) Patent Application Publication
(10) Pub. No.: US 2026/0242139 A1
(43) Pub. Date: Aug. 20, 2026

(54) Article Sorting Facility

(71) Applicant: Daifuku Co., Ltd., Osaka-shi (JP)

(72) Inventors: Toru Konagaya, Hinocho (JP); Akira Takeuchi, Hinocho (JP)

(21) Appl. No.: 18/724,663

(22) PCT Filed: Jul. 21, 2023
(86) PCT No.: PCT/JP2023/026755

§ 371 Date: May 8, 2026

(30) Foreign Application Priority Data
Jun. 29, 2023 (JP) 2023-107403

(51) Int. Cl. B65G 1/04; B65G 1/137

(52) U.S. Cl. CPC B65G 1/0492; B65G 1/1376

(57) ABSTRACT

A floor (E) on which multiple transport vehicles (20) travel includes a supply area (E1) including a supply unit (15), an aisle area (E3) extending along a Y direction, and a connection area (E2) connecting the supply area (E1) and the aisle area (E3). Multiple receivers (30) are located along the aisle area (E3). The aisle area (E3) includes an outgoing path and a return path aligned adjacent to each other along an X direction. The outgoing path is a path for the transport vehicles (20) to travel from a first end (51) of the aisle area (E3) to a reference turn position (53). The return path is a path for the transport vehicles (20) to travel from the reference turn position (53) to the first end (51). The aisle area (E3) includes a shortcut turn position (52) between the first end (51) and the reference turn position (53) along the Y direction to allow the transport vehicles (20) to perform a U-turn at the shortcut turn position (52)

### FIELD

The present invention relates to an article sorting facility in which multiple transport vehicles transport articles.

### BACKGROUND

Recent article transport facilities such as distribution warehouses have automated article transport systems. For example, Japanese Unexamined Patent Application Publication No. 2000-128318 (Patent Literature 1) describes an article sorting facility in which multiple transport vehicles (cage carts 2) transport articles (W).

### CITATION LIST

### Patent Literature

Patent Literature 1: Japanese Unexamined Patent Application Publication No. 2000-128318

### BRIEF SUMMARY

### Technical Problem

In the article sorting facility shown in FIG. 1 of Patent Literature 1, articles (W) are transferred between multiple storage shelves (7) and multiple transport vehicles (2) traveling on a track-like circulating transport path (F). However, for example, any transport vehicle (2) of the multiple transport vehicles (2) that transfers articles (W) simply to and from storage shelves (7) near the entrance of the track-like circulating transport path (F) travels throughout the track-like circulating transport path (F). This may be likely to lower the transport efficiency.

One or more aspects are directed to an article sorting facility that is likely to have high transport efficiency of articles with multiple transport vehicles.

### Solution to Problem

An article sorting facility according to an aspect of the disclosure is an article sorting facility for sorting articles transported by a plurality of transport vehicles traveling on a floor. The article sorting facility includes a supply unit that supplies the articles to the plurality of transport vehicles, and a plurality of receivers that receive the articles from the plurality of transport vehicles. A specific direction along the floor is a Y direction. A direction perpendicular to the Y direction and along the floor is an X direction. The Y direction extends in one direction being a first side in the Y direction and in the other direction being a second side in the Y direction. The floor includes an aisle area extending along the Y direction, a supply area located on a first side in the Y direction from the aisle area and including the supply unit, and a connection area connecting the aisle area and the supply area. The plurality of receivers are located along the aisle area. The aisle area includes an outgoing path and a return path aligned adjacent to each other along the X direction. The outgoing path is a path for the plurality of transport vehicles to travel from an end of the aisle area on the first side in the Y direction to a reference turn position set on a second side of the end in the Y direction. The return path is a path for the plurality of transport vehicles to travel from the reference turn position to the end after performing a U-turn at the reference turn position. The aisle area includes a shortcut turn position between the end and the reference turn position along the Y direction to allow the plurality of transport vehicles to perform a U-turn at the shortcut turn position.

This structure allows the transport vehicles receiving supply of articles at the supply unit to transport the articles to any of the multiple receivers located along the aisle area. The articles can thus be sorted into the multiple receivers. In the above structure, the outgoing path and the return path are aligned adjacent to each other along the X direction in the aisle area, with less likelihood of interference between multiple transport vehicles traveling back and forth in the aisle area. The above structure also includes the shortcut turn position between the first end of the aisle area on the first side in the Y direction and the reference turn position to allow the transport vehicles to perform U-turns at the shortcut turn position. The transport vehicles can thus perform U-turns along their paths to the reference turn position and return to the supply unit. The transport vehicles can thus perform U-turns at the shortcut turn position after transporting articles to the receivers that are located between the end on the first side in the Y direction and the shortcut turn position. This shortens the time taken for the transport vehicles to return to the supply unit. The structure is thus likely to increase the transportation efficiency of articles between the supply unit and the multiple receivers with multiple transport vehicles.

### BRIEF DESCRIPTION OF DRAWINGS

FIG. 1 is a top view of an article sorting facility according to an embodiment.

FIG. 2 is a front view of an aisle area in FIG. 1.

FIG. 3 is a control block diagram of the article sorting facility shown in FIG. 1.

FIG. 4 is an enlarged view of the aisle area illustrating a U-turn at a reference turn position in FIG. 1.

FIG. 5 is an enlarged view of the aisle area illustrating a U-turn at a shortcut turn position in FIG. 1.

### DETAILED DESCRIPTION

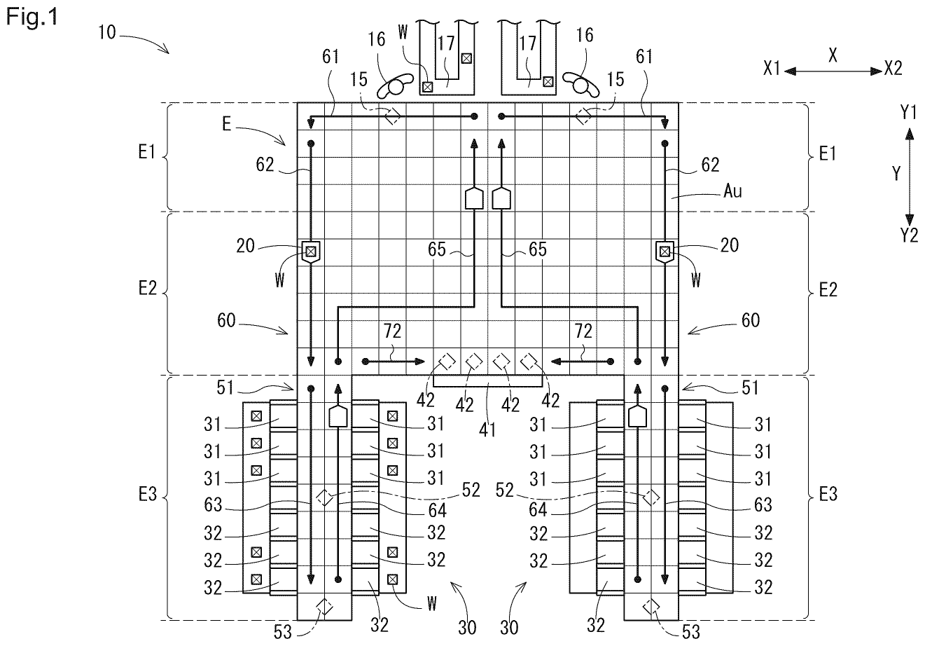

An article sorting facility 10 according to an embodiment will be described with reference to the drawings. FIG. 1 is a top view of the article sorting facility 10 for sorting articles W transported by multiple transport vehicles 20 traveling on a floor E. The article sorting facility 10 includes supply units 15 that supply articles W to the transport vehicles 20 and multiple receivers 30. The receivers 30 each receive articles W from the transport vehicles 20. In the present embodiment, the receivers 30 include first receivers 31 and second receivers 32 (described later).

In the present embodiment, an operating entity 16 transfers articles W to the transport vehicles 20 at each supply unit 15. The operating entity herein refers to, for example, an operator, an operating device, or both. The operating entity 16 transfers articles W from a supply transporter 17 to the transport vehicles 20. The supply transporter 17 transports articles W from an automated warehouse (not shown). Examples of the supply transporter 17 include a belt conveyor, a crane, and a robotic arm.

In this example, a specific direction along the floor E is referred to as the Y direction. A direction perpendicular to the Y direction and along the floor E is referred to as the X direction. The Y direction extends in one direction referred to as a first side Y1 along the Y direction and in the other direction referred to as a second side Y2 along the Y direction. The X direction extends in one direction referred to as a first side X1 along the X direction and in the other direction referred to as a second side X2 along the X direction. The direction parallel to the vertical direction is referred to as the Z direction. Examples of the floor E include transport surfaces on which vehicles travel and floors in buildings, ships, and other facilities. In the present embodiment, the floor E is a transport surface on an indoor platform.

The floor E includes a supply area E1 in which the supply unit 15 is located and an aisle area E3 extending along the Y direction. The supply area El is located on the first side Y1 along the Y direction from the aisle area E3. The floor E also includes a connection area E2 connecting the aisle area E3 and the supply area E1. The supply area E1, the connection area E2, and the aisle area E3 set on the floor E may each be an actually-divided area or a virtually-defined area on the floor E. In the present embodiment, the boundary between the supply area E1 and the connection area E2 is a virtual boundary on the floor E. In the present embodiment, the aisle area E3 has its two ends along the X direction being the outer edges of the floor E.

In the present embodiment, each supply area E1 includes a supply path 61. Each supply unit 15 described above may be located at the starting end or the terminal end of the corresponding supply path 61. In the example in the figure, each supply unit 15 is located in the middle of the corresponding supply path 61. In other words, each supply path 61 extends through the corresponding supply unit 15.

In the present embodiment, the connection area E2 connect the supply area E1 and the aisle area E3 to allow the transport vehicles 20 to travel between the areas. The connection area E2 include connection outgoing paths 62 for the transport vehicles 20 to travel from the supply area E1 to the aisle area E3. The connection area E2 also include connection return paths 65 for the transport vehicles 20 to travel from the aisle area E3 to the supply area E1. The aisle area E3 have first ends 51 on the first side Y1 along the Y direction. In the example in the figure, the connection area E2 connect the first ends 51 and the supply area E1.

Each aisle area E3 includes an outgoing path 63 for the transport vehicles 20 to travel from the first end 51, which is the end of the aisle area E3 on the first side Y1 along the Y direction, to a reference turn position 53 set on the second side Y2 along the Y direction from the first end 51. Each aisle area E3 also includes a return path 64 for the transport vehicles 20 to travel from the reference turn position 53 to the first end 51 after performing U-turns at the reference turn position 53. The outgoing path 63 and the return path 64 are aligned adjacent to each other along the X direction. Each aisle area E3 also includes a shortcut turn position 52 between the first end 51 and the reference turn position 53 along the Y direction to allow the transport vehicles 20 to perform U-turns at the shortcut turn position 52. In the present embodiment, the receivers 30 are located on both the first side Y1 and the second side Y2 along the Y direction from the shortcut turn position 52. The reference turn position 53 is at the second end of each aisle area E3. The second end is an end of the aisle area E3 on the second side Y2 along the Y direction.

The multiple receivers 30 are located along each aisle area E3. In the present embodiment, the receivers 30 are located along the Y direction on the two ends of each aisle area E3 along the X direction. In the outgoing path 63, the transport vehicles 20 deliver articles W to the receivers 30 located opposite to the return path 64 along the X direction. In the return path 64, the transport vehicles 20 deliver articles W to the receivers 30 located opposite to the outgoing path 63 along the X direction.

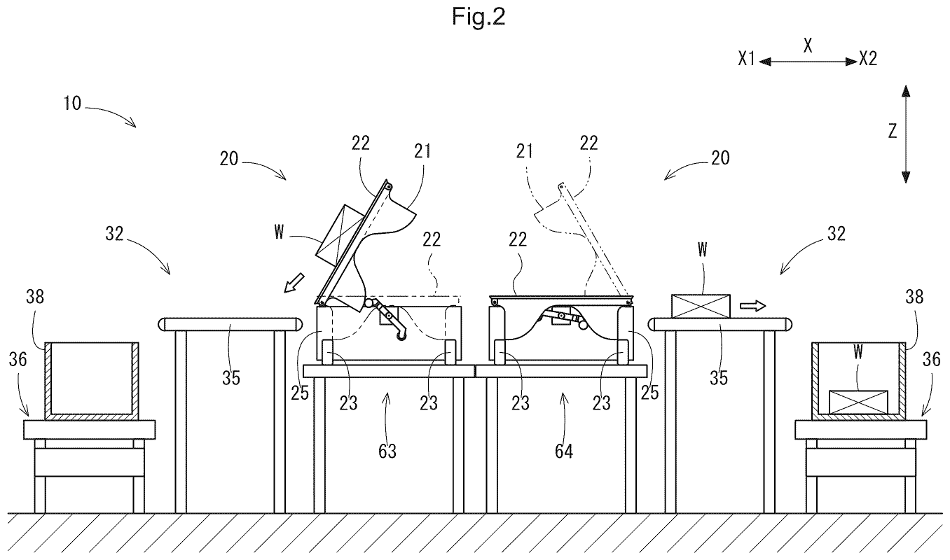

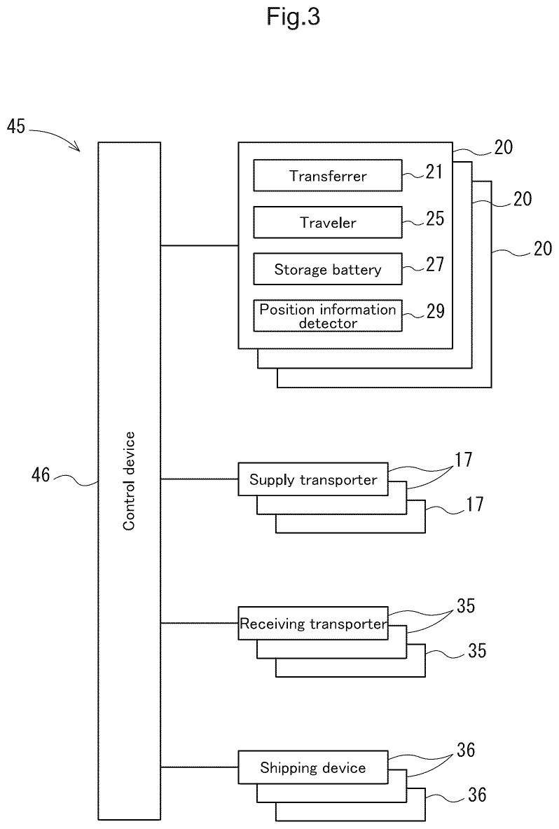

FIG. 2 is a front view of the aisle area E3. In the present embodiment, each transport vehicle 20 includes a transferrer 21 that transfers articles W from the transport vehicle 20 to the receivers 30 (the first receivers 31 and the second receivers 32). The transferrer 21 has a receiving surface 21a on which articles W are placeable. The receiving surface 21a is switchable between a horizontal orientation and an inclined orientation. When being transported, articles W are placed on the receiving surface 21a in the horizontal orientation. When the receiving surface 21a is in the inclined orientation, the articles W are transferred to the receivers 30. In the present embodiment, each transport vehicle 20 includes a traveler 25. The traveler 25 has multiple wheels 23 rolling on the transport surface on the floor E. Examples of the transport vehicles 20 include electric vehicles that travel on electricity supplied from storage batteries or fuel cells or through contact or contactless power feed from the floor E and include vehicles with internal combustion engines. In the present embodiment, a storage battery 27 (refer to FIG. 3) is mounted on the traveler 25 in each transport vehicle 20. The transport vehicles 20 are electric automatic guided vehicles.

In the present embodiment, each receiver 30 includes a receiving transporter 35. Articles W transferred to the receivers 30 are transported in a direction along the X direction by the receiving transporters 35 to be stored in containers 38 for the respective receivers 30. In the present embodiment, the receiving transporters 35 are adjacent to a shipping device 36. The containers 38 are arranged on the shipping device 36. When articles W of types and quantities specified in one piece of order information are placed in the container 38, the shipping device 36 transports the container 38 to the shipping location. Examples of the receiving transporter 35 include a belt conveyor, a crane, and a robotic arm. Examples of the shipping device 36 include a belt conveyor, a stacker crane, and an automatic guided vehicle.

Referring back to FIG. 1, in the present embodiment, the connection area E2 includes a charging position 42 for charging the transport vehicles 20 with a charger 41. The connection area E2 also include charge standby paths 72 on which multiple transport vehicles 20 can wait before being charged by the charger 41. This allows efficient use of the connection area E2, in which no supply unit 15 or no receiver 30 are located. In the example in the figure, the charger 41 is located adjacent to the connection area E2. The charging position 42 is arranged to allow multiple transport vehicles 20 to stop at the charging position 42.

In the present embodiment, each transport vehicle 20 moves to and stops at a charging position 42 when the remaining battery level is less than a predetermined level (e.g., less than 50% of the full capacity). At the charging position 42, the storage battery 27 in the transport vehicle 20 can be charged rapidly. In the example in the figure, the transport vehicles 20 move from the connection return paths 65 to stop at the charging position 42. The charged transport vehicles 20 return to the connection return paths 65. The charger 41 may be a contactless power feeder or a contact power feeder. In the present embodiment, a control device 46 included in a control system 45 (described later) obtains the remaining level of the storage battery 27 in each transport vehicle 20 and controls any transport vehicle 20 with less than a predetermined battery level to move to a charging position 42.

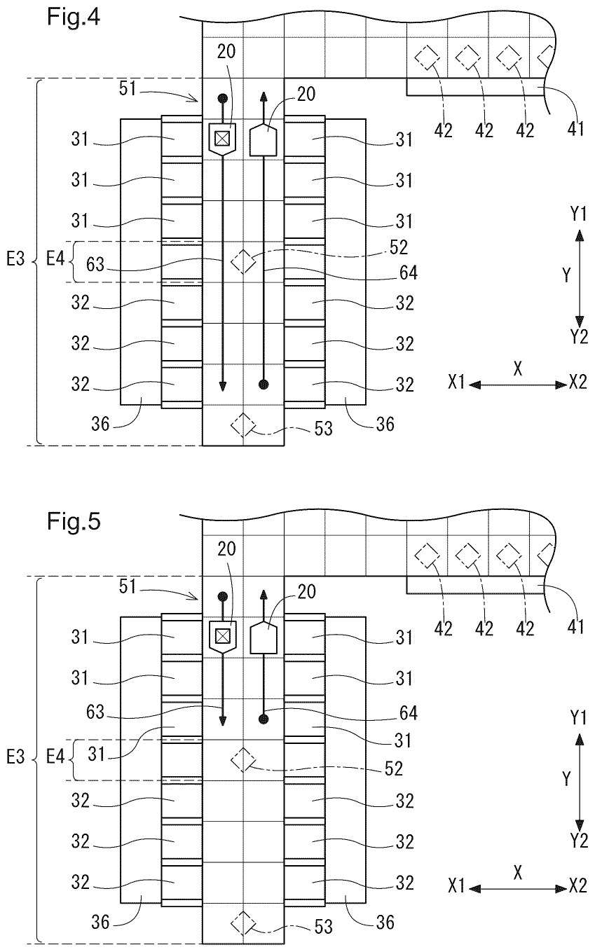

FIG. 3 is a control block diagram of the article sorting facility 10 according to the present embodiment. In the present embodiment, each transport vehicle 20 includes a position information detector 29. Travel paths 60 for the transport vehicles 20 set on the floor E include position information holders (not shown) at predetermined intervals. When the transport vehicles 20 travel on the travel paths 60, the position information detector 29 in each transport vehicle 20 detects the position information held by the position information holders. Examples of the position information holders include barcodes (one-dimensional codes), two-dimensional codes, and radio-frequency identification tags. The position information detected by the position information detector 29 is transmitted from each transport vehicle 20 to the control device 46 in the control system 45 (described later). In the present embodiment, the floor E is divided into multiple virtual subareas Au (refer to FIG. 4) in a grid as viewed in the direction along the Z direction. The travel paths for the transport vehicles 20 connect any number of virtual subareas Au to one another. The position information holders are located in, for example, the respective virtual subareas Au. In the present embodiment, the travel paths 60 for the transport vehicles 20 include the supply paths 61, the connection outgoing paths 62, the outgoing paths 63, the return paths 64, and the connection return paths 65.

In the present embodiment, the article sorting facility 10 includes the control system 45 that controls the transport vehicles 20. The control system 45 includes the control device 46 that controls the transferrers 21 and the travelers 25 in the transport vehicles 20. The control device 46 includes an arithmetic processor such as a central processing unit (CPU) and a main storage such as a random-access memory (RAM) or a read-only memory (ROM) that can be referenced by the arithmetic processor. The functions of the control device 46 (e.g., the function of controlling the travel of the transport vehicles 20) are implemented by the hardware in the control device 46 cooperating with a program executed on the arithmetic processor or other pieces of hardware. More specifically, each function of the control device 46 is implemented by the control device 46 executing a program stored in a storage (e.g., the main storage or a storage separate from the main storage). In other words, the program (e.g., an article sorting program) for causing a computer (a computer in the control system 45) to implement the functions of the control device 46 is stored in a storage that can be referenced by the computer. The program is provided by, for example, a storage medium or through a communication network. The provided program is then stored into a storage that can be referenced by the computer. In the present embodiment, the control device 46 (specifically, the arithmetic processor in the control device 46) functions as the computer. The control device 46 may be a set of multiple pieces of hardware (multiple separate pieces of hardware) that can communicate with each other through wires or wirelessly, rather than a single piece of hardware. For example, the control device 46 may include a host controller located in a control facility (not shown) to control the transport vehicles 20 and controllers mounted on the respective transport vehicles 20.

In the present embodiment, the control system 45 provides, for example, transport commands to each transport vehicle 20. The transport command specifies the source and the destination of an article W. In the present embodiment, the source is one of the supply units 15. The destination is one of the receivers 30. The transport command also specifies the travel paths for the transport vehicle 20 to use from the source to the destination. Upon receiving the transport command from the control system 45, the transport vehicle 20 receives an article W at the specified source and transports the article W to the specified destination.

The receivers 30 located on the first side Y1 along the Y direction from the shortcut turn position 52 are referred to as the first receivers 31. The receivers 30 located on the second side Y2 along the Y direction from the shortcut turn position 52 are referred to as the second receivers 32.

In the present embodiment, the control system 45 causes the transport vehicles 20 transporting articles W to the second receivers 32 to perform U-turns at the reference turn position 53. The control system 45 causes the transport vehicles 20 transporting articles W to the first receivers 31 to perform U-turns at the shortcut turn position 52. FIG. 4 is a diagram illustrating a U-turn of a transport vehicle 20 at the reference turn position 53. FIG. 5 is a diagram illustrating a U-turn of a transport vehicle 20 at the shortcut turn position 52.

In the present embodiment, the control system 45 is switchable between a normal mode and a partial operation mode. In the normal mode, the transport vehicles 20 transport articles W to both the first receivers 31 and the second receivers 32 of the receivers 30. In the partial operation mode, the transport vehicles 20 transport articles W to the first receivers 31 alone of the receivers 30.

The multiple receivers 30 located along each aisle area E3 include high-frequency receivers with the number of received articles W per unit time or the number of arrivals of transport vehicles 20 per unit time greater than or equal to a predetermined threshold and includes low-frequency receivers with the number of received articles W per unit time or the number of arrivals of transport vehicles 20 per unit time less than the threshold. In the present embodiment, the high-frequency receivers are located on the first side Y1 along the Y direction from the low-frequency receivers. The shortcut turn position 52 is set in a boundary area E4 between the area in which the high-frequency receivers are located and the area in which the low-frequency receivers are located along the Y direction. In the example in the figure, the first receivers 31 are the high-frequency receivers, and the second receivers 32 are the low-frequency receivers. In the example in the figure, the boundary area E4 is adjacent to the area in which the high-frequency receivers are located and the area in which the low-frequency receivers are located.

In the present embodiment, the aisle area E3 includes passing position. The control system 45 controls the transport vehicles 20 to avoid turning at the passing position. In the example in the figure, the passing position is other than the shortcut turn position 52 and the reference turn position 53 in the aisle area E3. The travel of the transport vehicles 20 is thus restricted to forward movement at the passing position, simplifying the control of the transport vehicles 20 performed by the control system 45. Although not shown, the shortcut turn position 52 has a larger width than each passing position along the X direction or the Y direction. When the transport vehicles 20 are rectangular or square as viewed in plan, this structure allows size reduction of the passing position, at which the transport vehicles 20 do not turn, while reducing the likelihood of the turning transport vehicles 20 protruding from the aisle area E3. The example structure in the figure includes no receiver 30 between the area in which the first receivers 31 are located and the area in which the second receivers 32 are located along the Y direction. This can increase the width of the shortcut turn position 52 along the X direction.

Referring back to FIG. 1, in the present embodiment, the multiple aisle areas E3 are aligned adjacent to each other along the X direction on the floor E. The first ends 51 of the aisle areas E3 are connected to each other by the connection areas E2. Thus, multiple receivers 30 are located along each of the multiple aisle areas E3, allowing transportation and sorting of articles W to many receivers 30. In the example in the figure, the article sorting facility 10 includes multiple supply units 15. The multiple supply areas E1 each including the supply unit 15 are aligned adjacent to each other along the X direction on the floor E. In the present embodiment, articles W can be transported by the transport vehicles 20 from the supply units 15 to the receivers 30 located along the aisle areas E3 and sorted into the receivers 30.

### Other Embodiments

Article sorting facilities 10 according to other embodiments will now be described.
(1) In the above embodiment, the multiple aisle areas E3 and the multiple supply areas E1 on the floor E are connected by the connection area E2 to allow the transport vehicles 20 to travel between the areas. However, the structure is not limited to such an example. For example, the multiple aisle areas E3 may be replaced with a single aisle area E3. For example, the multiple supply areas E1 may be replaced with a single supply area E1. For example, the multiple supply units 15 may be replaced with a single supply unit 15. For example, the connection area E2 may connect the supply area E1 and the aisle area E3 not to allow travel of the transport vehicles 20 between the areas. The transport vehicles 20 may be transferred by a transfer device between the supply area E1 and the connection area E2 or between the aisle area E3 and the connection area E2.
(2) In the above embodiment, the receivers 30 include both the first receivers 31 and the second receivers 32. However, the structure is not limited to such an example. For example, no receiver 30 may be located in the area on the first side Y1 along the Y direction from each shortcut turn position 52 or in the area on the second side Y2 along the Y direction from the shortcut turn position 52. The reference turn position 53 may be set in the middle of each aisle area E3, instead of at the end of the aisle area E3 on the second side Y2 along the Y direction. Multiple shortcut turn positions 52 may be set between the first end 51 and the reference turn position 53 of the aisle area E3 along the Y direction.
(3) In the above embodiment, the supply area E1 and the connection area E2 are separated by a virtual boundary, with the two ends of aisle area E3 along the X direction being the outer edges of the floor E. However, the structure is not limited to such an example. For example, the supply area E1, the connection area E2, and the aisle area E3 may be defined by the actual outer edges of the floor E in which the transport vehicles 20 can travel. For example, all of the supply area E1, the connection area E2, and the aisle area E3 may be virtually-defined areas on a large floor E. For example, an area different from the supply area E1, the connection area E2, and the aisle area E3 may be set on the floor E. Examples of such area includes a buffer area in which multiple transport vehicles 20 can be in line.
(4) In the above embodiment, the control system 45 controls transport vehicles 20 transporting articles W to the second receivers 32 to perform U-turns at the reference turn position 53 and controls transport vehicles 20 transporting articles W to the fist receivers 31 to perform U-turns at the shortcut turn position 52. However, the structure is not limited to such an example. For example, the control system 45 may control transport vehicles 20 transporting articles W to the first receivers 31 to perform U-turns at the reference turn position 53. The control system 45 may simply have the normal mode without having the partial operation mode.
(5) In the above embodiment, the high-frequency receivers are located on the first side Y1 along the Y direction from the low-frequency receivers. However, the structure is not limited to such an example. For example, the high-frequency receivers may be located on the second side Y2 along the Y direction from the low-frequency receivers. For example, the boundary area E4 may be adjacent to either the area in which the high-frequency receivers are located or the area in which the low-frequency receivers are located, or may be adjacent to neither of the areas. For example, the high-frequency receivers and the low-frequency receivers may not be set.
(6) In the above embodiment, the control system 45 includes the host controller that controls the transport vehicles 20 and controllers mounted on the respective transport vehicles 20. However, the structure is not limited to such an example. For example, the control system 45 may be a system in which the controller on each transport vehicle 20 communicates with the controller on another transport vehicle 20 to autonomously determine the operation.
(7) In the above embodiment, the control system 45 controls the transferrer 21 and the traveler 25 in each transport vehicle 20. However, the structure is not limited to such an example. For example, the control device 46 may control the traveler 25 in each transport vehicle 20 alone. For example, each transport vehicle 20 may include no transferrer 21, and the operating entities 16 may transfer articles W on the transport vehicles 20. Articles W may be stored in compartments in the transport vehicles 20. The control system 45 may control the operation devices, which are the operating entities 16.
(8) In the above embodiment, the travel paths 60 for the transport vehicles 20 include the supply paths 61, the connection outgoing paths 62, the outgoing paths 63, the return paths 64, and the connection return paths 65. However, the structure is not limited to such an example. For example, the travel paths 60 may simply include the outgoing paths 63 and the return paths 64. For example, the travel paths 60 may include a charge standby path 72. For example, the travel paths 60 may include no position information holder. The position information about the transport vehicles 20 may be obtained by the transport vehicles 20 or image sensors installed in the facility.
(9) In the above embodiment, the article sorting facility 10 includes the supply transporters 17, the receiving transporters 35, and the shipping devices 36. However, the structure is not limited to such an example. For example, the article sorting facility 10 may include no supply transporter 17, no receiving transporter 35, and no shipping device 36. Operators or vehicles operated by operators may transport the articles W or the containers 38.
(10) The structure described in each of the above embodiments may be combined with any other structures described in the other embodiments unless any contradiction arises. The embodiments described herein are merely illustrative in all aspects and may be modified variously as appropriate without departing from the spirit and scope of the disclosure.

### Overview of Embodiments

Hereafter, the article sorting facility will be described.

An article sorting facility according to an aspect of the disclosure is an article sorting facility for sorting articles transported by a plurality of transport vehicles traveling on a floor. The article sorting facility includes a supply unit that supplies the articles to the plurality of transport vehicles, and a plurality of receivers that receive the articles from the plurality of transport vehicles. A specific direction along the floor is a Y direction. A direction perpendicular to the Y direction and along the floor is an X direction. The Y direction extends in one direction being a first side in the Y direction and in the other direction being a second side in the Y direction. The floor includes an aisle area extending along the Y direction, a supply area located on a first side in the Y direction from the aisle area and including the supply unit, and a connection area connecting the aisle area and the supply area. The plurality of receivers are located along the aisle area. The aisle area includes an outgoing path and a return path aligned adjacent to each other along the X direction. The outgoing path is a path for the plurality of transport vehicles to travel from an end of the aisle area on the first side in the Y direction to a reference turn position set on a second side of the end in the Y direction. The return path is a path for the plurality of transport vehicles to travel from the reference turn position to the end after performing a U-turn at the reference turn position. The aisle area includes a shortcut turn position between the end and the reference turn position along the Y direction to allow the plurality of transport vehicles to perform a U-turn at the shortcut turn position.

This structure allows the transport vehicles receiving supply of articles at the supply unit to transport the articles to any of the multiple receivers located along the aisle area. The articles can thus be sorted into the multiple receivers. In the above structure, the outgoing path and the return path are aligned adjacent to each other along the X direction in the aisle area, with less likelihood of interference between multiple transport vehicles traveling back and forth in the aisle area. The above structure also includes the shortcut turn position between the first end of the aisle area on the first side in the Y direction and the reference turn position to allow the transport vehicles to perform U-turns at the shortcut turn position. The transport vehicles can thus perform U-turns along their paths to the reference turn position and return to the supply unit. The transport vehicles can thus perform U-turns at the shortcut turn position after transporting articles to the receivers that are located between the end on the first side in the Y direction and the shortcut turn position. This shortens the time taken for the transport vehicles to return to the supply unit. The structure is thus likely to increase the transportation efficiency of articles between the supply unit and the multiple receivers with multiple transport vehicles.

In one aspect, the article sorting facility may further include a control system that controls the plurality of transport vehicles. The plurality of receivers may include a first receiver located on the first side in the Y direction from the shortcut turn position, and a second receiver located on the second side in the Y direction from the shortcut turn position. The control system may cause a transport vehicle of the plurality of transport vehicles transporting an article to the second receiver to perform a U-turn at the reference turn position and cause a transport vehicle of the plurality of transport vehicles transporting an article to the first receiver to perform a U-turn at the shortcut turn position.

This structure causes the transport vehicles to perform U-tuns at the shortcut turn position after transporting articles to the receivers that are located between the first end on the first side in the Y direction and the shortcut turn position while allowing transportation of articles to the receivers located in the area toward the reference turn position from the shortcut turn position, shortening the return time of the transport vehicles to the supply unit. This structure is thus likely to increase the transportation efficiency of articles between the supply unit and the multiple receivers with multiple transport vehicles.

In one aspect, the article sorting facility may further include a control system that controls the plurality of transport vehicles. The plurality of receivers may include a first receiver located on the first side in the Y direction from the shortcut turn position, and a second receiver located on the second side in the Y direction from the shortcut turn position. The control system may be switchable between a normal mode to cause the plurality of transport vehicles to transport the articles to both the first receiver and the second receiver of the plurality of receivers and a partial operation mode to cause the plurality of transport vehicles to transport the articles to the first receiver alone of the plurality of receivers.

In the above structure, the normal mode may be set for, for example, more sorting destinations to use both the first receivers and the second receivers as transportation destinations. For fewer sorting destinations, the partial operation mode may be set to use, as transportation destinations, the first receivers alone located on the first side in the Y direction from the shortcut turn position. The partial operation mode causes the transport vehicles to perform U-turns at the shortcut turn position, shortening the time for the transport vehicles to return to the supply unit. This structure is thus likely to increase the transportation efficiency of articles between the supply unit and the multiple receivers with multiple transport vehicles.

In one aspect, the plurality of receivers located along the aisle area may include a high-frequency receiver with a number of articles received per unit time or a number of arrivals of transport vehicles per unit time greater than or equal to a predetermined threshold, and a low-frequency receiver with the number of articles received per unit time or the number of arrivals of transport vehicles per unit time less than the predetermined threshold. The high-frequency receiver may be located on the first side in the Y direction from the low-frequency receiver. The shortcut turn position may be set in a boundary area between a first area and a second area in the Y direction, the first area being an area in which the high-frequency receiver is located, the second area being an area in which the low-frequency receiver is located.

This structure allows fewer transport vehicles to travel farther than the shortcut turn position on the second side in the Y direction and allows more transport vehicles to perform U-turns at the shortcut turn position. This structure is thus likely to increase the transportation efficiency of articles between the supply unit and the multiple receivers with multiple transport vehicles.

In one aspect, the plurality of receivers may be arranged along the Y direction on two ends of the aisle area along the X direction. In the outgoing path, the plurality of transport vehicles may deliver the articles to a receiver of the plurality of receivers which receiver is located opposite to the return path along the X direction. In the return path, the plurality of transport vehicles may deliver the articles to a receiver of the plurality of receivers which receiver is located opposite to the outgoing path along the X direction.

This structure allows delivery of articles to the receivers along both the outgoing path and the return path in the aisle area. Thus, articles can be efficiently sorted into many receivers in one aisle area.

### REFERENCE SIGNS LIST

10 article sorting facility
15 supply unit
20 transport vehicle
30 receiver
31 first receiver
32 second receiver
45 control system
51 first end (end)
52 shortcut turn position
53 reference turn position
63 outgoing path
64 return path
E floor
E1 supply area
E2 connection area
E3 aisle area
W article

1. An article sorting facility for sorting articles transported by a plurality of transport vehicles traveling on a floor, the article sorting facility comprising:
a supply unit configured to supply the articles to the plurality of transport vehicles; and
a plurality of receivers configured to receive the articles from the plurality of transport vehicles, and
wherein:
a specific direction along the floor being-is a Y direction, a direction perpendicular to the Y direction and along the floor being-is an X direction, the Y direction extending in one direction being-is a first side in the Y direction and in the other direction being-is a second side in the Y direction,
the floor in
an aisle area extending along the Y direction;
a supply area located on a first side along the Y direction from the aisle area and including the supply unit ; and
a connection area connecting the aisle area and the supply area,
the plurality of receivers being-is located along the aisle area,
the aisle area includes an outgoing path and a return path aligned adjacent to each other along the X direction, the outgoing path is a path for the plurality of transport vehicles to travel from an end of the aisle area on the first side along the Y direction to a reference turn position set on a second side along the Y direction from the end, the return path is a path for the plurality of transport vehicles to travel from the reference turn position to the end after performing a U-turn at the reference turn position, and
the aisle area includes a shortcut turn position between the end and the reference turn position along the Y direction to allow the plurality of transport vehicles to perform a U-turn at the shortcut turn position.

2. The article sorting facility according to claim 1, further comprising:
a control system configured to control the plurality of transport vehicles, and
wherein
the plurality of receivers comprises:
a first receiver located in on the first side along the Y direction from the shortcut turn position; and
a second receiver located in on the second side along the Y direction from the shortcut turn position, and
the control system causes a transport vehicle of the plurality of transport vehicles transporting an article to the second receiver to perform a U-turn at the reference turn position and causes a transport vehicle of the plurality of transport vehicles transporting an article to the first receiver to perform a U-turn at the shortcut turn position.

3. The article sorting facility according to claim 1, further comprising:
a control system configured to control the plurality of transport vehicles, and
wherein:
the plurality of receivers comprises;
a first receiver located on the first side along the Y direction from the shortcut turn positions and
a second receiver located on the second side along the Y direction from the shortcut turn position, and
the control system is switchable between a normal mode to cause the plurality of transport vehicles to transport the articles to both the first receiver and the second receiver of the plurality of receivers and a partial operation mode to cause the plurality of transport vehicles to transport the articles to the first receiver alone of the plurality of receivers.

4. The article sorting facility according to claim 1, wherein.
the plurality of receivers located along the aisle area
a high-frequency receiver with a number of articles received per unit time or a number of arrivals of transport vehicles per unit time greater than or equal to a predetermined threshold; and
a low-frequency receiver with the number of articles received per unit time or the number of arrivals of transport vehicles per unit time less than the predetermined threshold,
the high-frequency receiver is located on the first side along the Y direction from the low-frequency receiver, and
the shortcut turn position is set in a boundary area between a first area and a second area in the Y direction, the first area being an area in which the high-frequency receiver is located the second area being an area in which the low-frequency receiver is located.

5. The article sorting facility according to claim 1, wherein;
the plurality of receivers is arranged along the Y direction on two ends of the aisle area along the X direction,
in the outgoing path, the plurality of transport vehicles deliver the articles to a receiver of the plurality of receivers which receiver is located opposite to the return path in the X direction, and
in the return path, the plurality of transport vehicles deliver the articles to a receiver of the plurality of receivers which receiver is located opposite to the outgoing path in the X direction.

6. The article sorting facility according to claim 2, further comprising:
a control system configured to control the plurality of transport vehicles, and
wherein:
the plurality of receivers comprises:
a first receiver located on the first side along the Y direction from the shortcut turn position; and
a second receiver located on the second side along the Y direction from the shortcut turn position, and
the control system is switchable between a normal mode to cause the plurality of transport vehicles to transport the articles to both the first receiver and the second receiver of the plurality of receivers and a partial operation mode to cause the plurality of transport vehicles to transport the articles to the first receiver alone of the plurality of receivers.

7. The article sorting facility according to claim 2, wherein:
the plurality of receivers located along the aisle area comprises:
a high-frequency receiver with a number of articles received per unit time or a number of arrivals of transport vehicles per unit time greater than or equal to a predetermined threshold; and
a low-frequency receiver with the number of articles received per unit time or the number of arrivals of transport vehicles per unit time less than the predetermined threshold,
the high-frequency receiver is located on the first side along the Y direction from the low-frequency receiver, and
the shortcut turn position is set in a boundary area between a first area and a second area in the Y direction, the first area being an area in which the high-frequency receiver is located the second area being an area in which the low-frequency receiver is located.

8. The article sorting facility according to claim 2, wherein:
the plurality of receivers is arranged along the Y direction on two ends of the aisle area along the X direction,
in the outgoing path, the plurality of transport vehicles deliver the articles to a receiver of the plurality of receivers which receiver is located opposite to the return path in the X direction, and
in the return path, the plurality of transport vehicles deliver the articles to a receiver of the plurality of receivers which receiver is located opposite to the outgoing path in the X direction.
